(19) United States
(12) Patent Application Publication
(10) Pub. No.: US 2015/0046209 A1
(43) Pub. Date: Feb. 12, 2015

(54) SYSTEM AND METHOD FOR PROVIDING CALENDAR SERVICES TO USERS

(71) Applicant: slipcal, PBC, San Francisco, CA (US)

(72) Inventor: Brian Choe, San Francisco, CA (US)

(21) Appl. No.: 14/454,627

(22) Filed: Aug. 7, 2014

Related U.S. Application Data
(60) Provisional application No. 61/864,029, filed on Aug. 9, 2013.

(51) Int. Cl. G06Q 10/10

(52) U.S. Cl. CPC G06Q 10/1095
USPC 705/7.19

(57) ABSTRACT

A method for providing a calendar service to a first user is provided. A user interface is provided to a computing device of the first user. The user interface includes a calendar of the first user. The first user is associated with a calendar of a second user. The first user can view, on the calendar associated with the first user, one or more activities offered by the second user. The one or more activities are capable of being individually joined by the first user. A user input to join an activity offered by the second user is received. In response to receiving the user input, an entry for the joined activity is added in the calendar of the first user, and information for the accepted activity is modified in the calendar of the second user.

### RELATED APPLICATION

This application claims benefit of priority to Provisional U.S. Patent Application No. 61/864,029, filed Aug. 9, 2013, entitled “SYSTEM AND METHOD FOR PROVIDING CALENDAR SERVICES TO USERS”; the aforementioned priority application being hereby incorporated by reference in its entirety.

### BACKGROUND

Current time management or calendar services maintain a calendar for a user and enable the user to access the calendar from any one of the user's computing devices. Conventional approaches for calendar systems, however, are not efficient in facilitating business or arranging a scheduled activity between two or more users.

### BRIEF DESCRIPTION OF THE DRAWINGS

FIG. 1 illustrates an example calendar management system, according to an embodiment.

FIG. 2 illustrates an example method for providing calendar services to a user, in one embodiment.

FIG. 3 illustrates another example method for providing calendar services to a user, in another embodiment.

FIGS. 4A and 4B illustrate example user interfaces that are displayed on a user's computing device, in one embodiment.

FIGS. 5A through 5M illustrate other example user interfaces that are displayed on a user's computing device, in another embodiment.

FIG. 6 is a block diagram that illustrates a computer system upon which embodiments described herein may be implemented.

### DETAILED DESCRIPTION

Embodiments described herein provide for a system and method for providing a calendar system that enable users of the calendar system to associate with each other. The calendar system can maintain personal calendars for users and provide a medium to facilitate commerce and/or scheduling of events or activities between users.

According to embodiments, the system maintains one or more calendars for individual users and enables users to follow or associate with calendars of other users. A user interface is provided to a first user, for example, that includes a calendar associated with or belonging to the first user. The first user is enabled to select one or more other users and/or users' calendars to follow or associate with. Based on the first user's selection, the system associates the first user with a calendar of a second user and enables the first user to view on his or her calendar, activities that are offered by the second user.

In some instances, one or more activities provided by the second user can be business-oriented or business-related services that are offered by the second user and are capable of being individually selected and joined by the first user. In other examples, activities provided by the second user can also be personal events. When the first user requests to join an activity offered by the second user, the system adds an entry for the joined activity in the calendar of the first user and modifies information for the activity in the calendar of the second user.

The system enables a user to create and/or manage one or more activities the user wants to offer or share with other users. For example, the calendar user interface can include an activities section in which the user can create new activities and view/edit/delete activities that he or she has previously created. When the user wants to offer an activity to other users, the user can select the activity from the activities section and drag the selected activity to a particular time frame or duration on the calendar. The user's calendar is dynamically updated with the new activity and other users that are following (or are associated with) the user can view the newly offered activity on their respective calendar interfaces. In this manner, a scheduled activity can be arranged between two or more users without need for extensive manual interaction between the users.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices, such as servers, desktop computers, cellular or smartphones, laptop computers, printers, digital picture frames, network equipments, and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

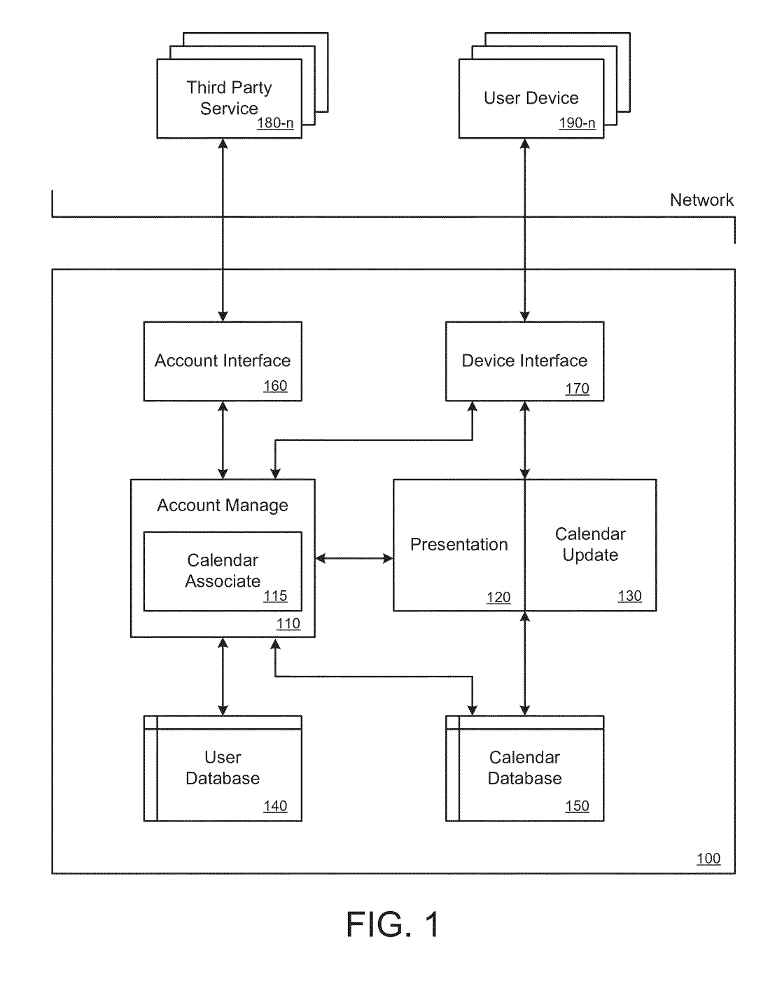

FIG. 1 illustrates an example calendar management system, according to an embodiment. For example, FIG. 1 illustrates a system that enables activities or services to be arranged between users of the system through interactions with calendar interfaces. Users of the system can associate with other users and/or calendars of other users to view activities that are being offered by the other users. A system such as described can be implemented in various contexts.

In one embodiment, system 100 includes an account manage 110, a presentation component 120, a calendar update 130, a user database 140, a calendar database 150, and account and device interfaces 160, 170, respectively. The components of system 100 can combine to provide a time-management or calendar service to a plurality of users (that operate user devices 190) and enable activities of services to be arranged between the users via their respective calendars. In one example, the components of system 100 can be implemented on network side resources, such as on one or more servers. One or more components of system 100 can also be implemented through other computer systems in alternative architectures (e.g., peer-to-peer networks, etc.).

As an alternative or addition, some or all of the components of system 100 can be implemented on client machines, such as through applications that operate on the user devices 190. For example, a client application, such as a browser, can execute to perform one or more of the processes described by the various components of system 100. System 100 can communicate over a network, via a network interface (e.g., wirelessly or using a wireline), to communicate with the user devices 190.

The device interface 170 manages communications between system 100 and the user devices 190. A user device 190 is a computing device, such as a desktop computer, smartphones, laptop computer, tablet device, etc. A user device 190 can operate a browser application or a calendar application that can interface with the device interface 170 in order to provide information to and/or receive information from system 100. A user that operates a browser on the user's device 190 can communicate with system 100 by viewing and interacting with a webpage or application interface provided by system 100. In another example, a calendar application can include or use an application programming interface (API) to communicate data with the device interface 170.

A user can sign up and create an account to receive calendar services provided by system 100. A new user, for example, can access a webpage or application from the user's computing device 190 and choose to set up a business calendar and/or a personal calendar. In some examples, a user can have multiple calendars associated with the user (e.g., a business calendar, a second business calendar, a personal calendar, a calendar for a club or organization the user participates in, a calendar for a resource such as a shared car or apartment, etc.). When signing up for an account, the user can provide information that will be stored for the user in a user database 140 (e.g., with a user account or profile). Such information can include a username and password, the user's name or business name, contact information (e.g., address, phone number, email address, webpage/website URL, etc.), and/or other information (e.g., birthday, financial information, etc.). For a business calendar, in particular, the user can also provide what type of business or services are being offered by the user (e.g., instrument lessons, haircuts, massages, acupunctures, wedding planning, photography, babysitting, etc.). The account manage 110 can receive information provided by a user and store the information with the user's account or profile in the user database 140.

In addition, the account manage 110 can interact with the calendar update 130 to cause a calendar (or multiple calendars) to be created for the user and be associated with the user's account or profile. For example, the user profile can be stored in the user database 140 with a corresponding user identifier and a calendar identifier for the user. Similarly, the calendar can include the calendar identifier and be associated with the user identifier of the user. The calendar and associated information can be stored in the calendar database 150.

After an account is created for a user and is associated with a calendar for the user, the user can log in (e.g., by interacting with a webpage provided on a browser or an application running on the user's computing device) to access the user's calendar. The account manage 110 can authenticate the user and/or the user's computing device 190 by checking the inputted username and password with the stored username and password for the user in the user database 140 (e.g., to determine if there is a match). Once the user is authenticated, the user can access the webpage or application to view the user's associated calendar(s).

A presentation component 120 can be provided to generate graphic user interfaces for output to the users. For example, system 100 may provide graphic user interfaces and calendar information on, for example, a webpage that is available to users via a web browser application, which connects to a specific webpage or network location to generate content to be displayed on the user's device 190. Alternatively, system 100 may provide calendar information through applications that execute on user devices 190 (e.g., a calendar application). For an individual user, the output of the presentation component 120 can include a calendar(s) for that user with entries that have been scheduled by the user, and information about other users and/or calendars that the user is following (or is associated with).

Users can interact with the graphic user interfaces to create and/or manage calendar entries in the users' respective calendar(s). In one example, a user can create a calendar entry by interacting with the displayed calendar (e.g., selecting a time period and entering in appropriate descriptive information). In another example, the user can create an entry by first creating an activity that is offered by the user, and select, drag, and drop a selectable feature for the activity onto a specific time period on the displayed calendar. When a user creates, edits, or deletes calendar entries by interacting with the calendar interface, the calendar update 130 can update the respective calendar with the modified information. For example, a user's calendar stored in the calendar database 150 can have a plurality of entries that are associated with the user's calendar. Each calendar entry can include a plurality of information, such as a name, description, date, duration (e.g., start time and end time), cost for the service provided, location, etc. In this manner, the calendar update 130 can maintain calendar information for individual users in the calendar database 150, so that when a user revisits the calendar webpage at a later time, for example, the presentation component 120 can retrieve the appropriate calendar entries and information about the user's calendar for display for the specific user.

A user can also interact with various features (provided on the graphic user interface) to follow or link to other users and/or other users' calendars. In one implementation, the account manage 115 can include or communicate with a calendar associate 115. The calendar associate 115 can associate or link a user with another user and/or the other user's calendar. For example, the user can search for friends to view their friends' calendars or search for particular users that can provide certain services the user wants in the user's geographic area. When the user performs a query (e.g., inputs a name, email address, or username of a friend, or inputs a particular service requested), the calendar associate 115 can perform a search of the user database 140 and/or the calendar database 150 to find users and/or calendars of users that satisfy the user's search term or criteria. The search results can be provided to the user device 190 via the device interface 170.

The user can select one or more users and/or users' calendars to follow or associate with. When the user selects another user to follow (e.g., a friend) or a calendar of another user (e.g., a calendar of a business owner that provides piano lessons), for example, the calendar associate 115 updates the user's account or profile in the user database 140 to associate that user with an account of the other user or the calendar of the other user, respectively. In some embodiments, when a first user selects to follow a second user or calendar of the second user, the calendar associate 115 can cause a notification or message to be sent to the second user, notifying the second user that the first user has requested to follow him or her. The first user can only follow the second user once the second user has approved or agreed to allow the first user to follow him or her.

When a user follows another user's calendar, the presentation component 120 enables information about the followed user's calendar to also be displayed on the user's calendar. For example, a first user can choose to follow a second user (e.g., a stylist) or a calendar of the second user. The second user can interact with system 100 to view her calendar and create entries for activities (e.g., haircut for $30, perm for $100, etc.) that she is offering. The second user can use her calendar for personal matters (e.g., appointments with friends, lunch breaks, scheduled vacations, etc.) and see what time durations or time slots she is available for providing such services. The second user can then select, drag, and drop an activity (e.g., haircut) to one or more time slots on her calendar. The calendar update 130 adds an entry(ies) for one or more activities in the second user's calendar in the calendar database 150. Because the first user follows the second user, the first user can toggle a feature, for example, on his calendar user interface, to view calendar information of the second user. The first user can view, on his calendar, the available time slots for the activity (e.g., haircut) being offered by the second user. When the first user signs up or joins the activity (e.g., he wants to get a haircut from the second user) at a particular available time slot, the calendar update 130 adds the entry for the activity in the first user's calendar at that time slot and updates the first user's calendar in the calendar database 150. The calendar update 130 (e.g., subsequently or simultaneously) also updates the second user's calendar by updating the activity at that time slot with information about the first user.

The account manage 110 can also communicate with the presentation component 120 and the calendar update 130 to provide notifications or messages to users of system 100. For example, a first user that follows a second user or the second user's calendar can receive a notification when a new offered activity is added to the second user's calendar. The calendar update 130 can update the calendar of the second user in the calendar database 150 and provide the account manage 110 with information about the update (e.g., calendar identifier and/or user identifier for the calendar). The account manage 110 can identify which users, from the user database 140, are following the second user, and cause the presentation component 120 to provide information in the form of a notification or message to the respective users (including the first user) that the second user is offering additional classes or activities.

In some examples, system 100 can also communicate with other third party services 180 (e.g., other time management or calendar services, social networking services, email services, etc.) to consolidate calendar information for individual users. For example, a user can update his or her account with information from other third party services 180 that the user uses. The user can provide the account manage 110 with usernames and passwords for the other third party services 180 so that the account interface 160 can retrieve calendar information from the other third party services 180 that the user uses. In this manner, a calendar entry for a user stored in another third party calendar service can be included in the calendar graphic user interface provided by system 100.

As an addition or alternative, system 100 can also include a transaction component (not shown in FIG. 1) that enables payment to be received/made for services provided/received for or by users. A user account can include a payment method (e.g., credit card, checking account, Paypal, etc.) with specific payment information (e.g., billing name, address, credit card number, gift card number, bank account number, routing number, etc.). A user can be charged for services (i) when he or she signs up for an activity (e.g., haircut or piano lesson), (ii) at a duration of day/time before the scheduled activity time, or (iii) when he or she finishes receiving services for the signed up activity (one or both users indicate that service has been rendered). In some examples, payment can be made for one-time services or activities. In another example, a business owner (e.g., a yoga instructor) can provide packs of a service (e.g., yoga classes) to be purchased by a user (e.g., buy 20 yoga class sessions for a discounted rate). The transaction component can interact with the users' financial services via the stored payment information to allow payment to be made and/or received automatically.

In another embodiment, system 100 can also include a reporting component (not shown in FIG. 1) that maintains a history database of a history of activities that have been offered by users and/or participated or signed up by users. In some examples, this database can be a part of or included with the user database 140 and/or the calendar database 150. A user offering services, such as yoga classes, can generate activity reports (via interaction with the graphic user interfaces) for a customer, e.g., to let the customer or service provider know how many classes the customer has currently signed up for, how much they have paid, when those classes are taking place, a cumulative record of classes the customer has already taken, etc.

In some variations, some of the components that are described in system 100 can be provided as being individual components or as being part of the same component. For example, the presentation component 120 and/or the calendar update 130 can be provided as a part of the account manage 110. In another example, the user database 140 and the calendar database 150 can be a part of the same database. Logic can be implemented with various applications (e.g., software) and/or with hardware of a computer system that implements system 100.

Methodology

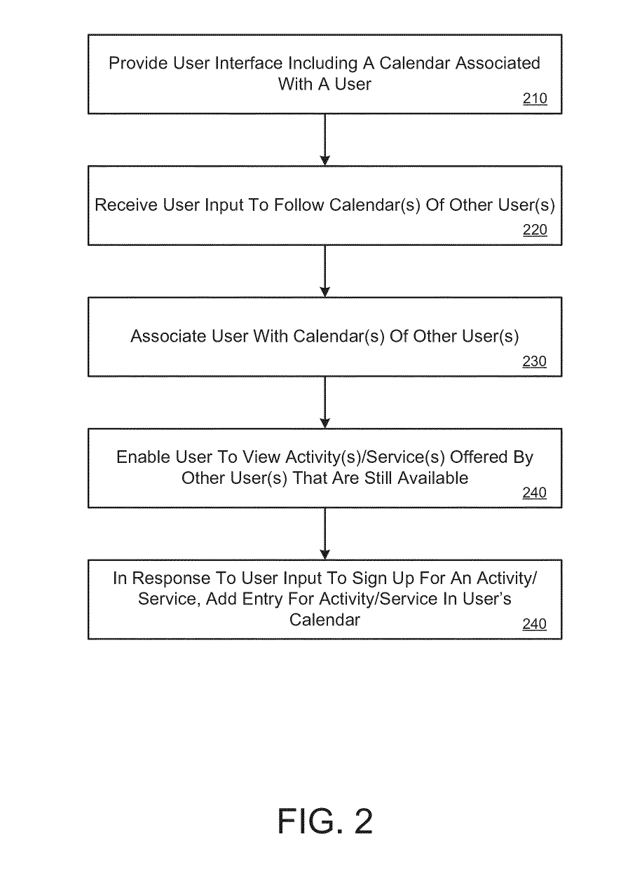

FIG. 2 illustrates an example method for providing calendar services to a user, in one embodiment. A method such as described by an embodiment of FIG. 2 can be implemented using, for example, components described with an embodiment of FIG. 1. Accordingly, references made to elements of FIG. 1 are for purposes of illustrating a suitable element or component for performing a step or sub-step being described.

The calendar system, such as system 100 of FIG. 1, can provide a graphical user interface to a first user (210). The graphical user interface can include a calendar of the first user and other associated information pertaining to the calendar and/or the first user (e.g., other users the first user is following or is associated with, users that are following the first user, etc.). The first user can interact with the graphical user interface from any one of the user's computing devices.

In one example, the calendar system can receive a user input that requests to follow another user (e.g., a second user) and/or a calendar of the other user (220). Depending on implementation, the calendar system can notify the second user that the first user is requesting to follow her calendar. For example, the second user can modify her settings and/or account so that in order for other users to follow her, she must first give approval. In other examples, the second user can modify her account settings so that any user can follow her and/or her calendar.

The calendar system associates the first user with the calendar of the second user (230). Once the first user is enabled to follow the second user or the calendar of the second user, the first user is enabled to view one or more activities/services that are offered by the second user and that are available for the first user to join (240). The first user can view the one or more activities on the first user's own calendar. For example, if the second user offers a one-on-one piano lesson from 4 pm to 5 pm on Monday and no other user has yet signed up for that piano lesson, the first user can view the activity (e.g., because it is available/capable of being joined or signed up by the first user). On the other hand, piano lessons offered by the second user that have already been booked will not be visible on the first user's calendar (but will be visible by the second user on the second user's own calendar as being booked by another user).

The first user can sign up or join an activity/service that is offered by the second user. In response to the user input to sign up for the activity, the calendar system adds an entry for the signed up activity in the calendar of the first user, and modifies information for the signed up activity in the calendar of the second user (240). In one example, the calendar system can modify the entry corresponding to the activity in the calendar of the second user by changing the status of the activity (e.g., from available to booked) and providing information about the user (e.g., name, contact information of the first user) that signed up for the activity.

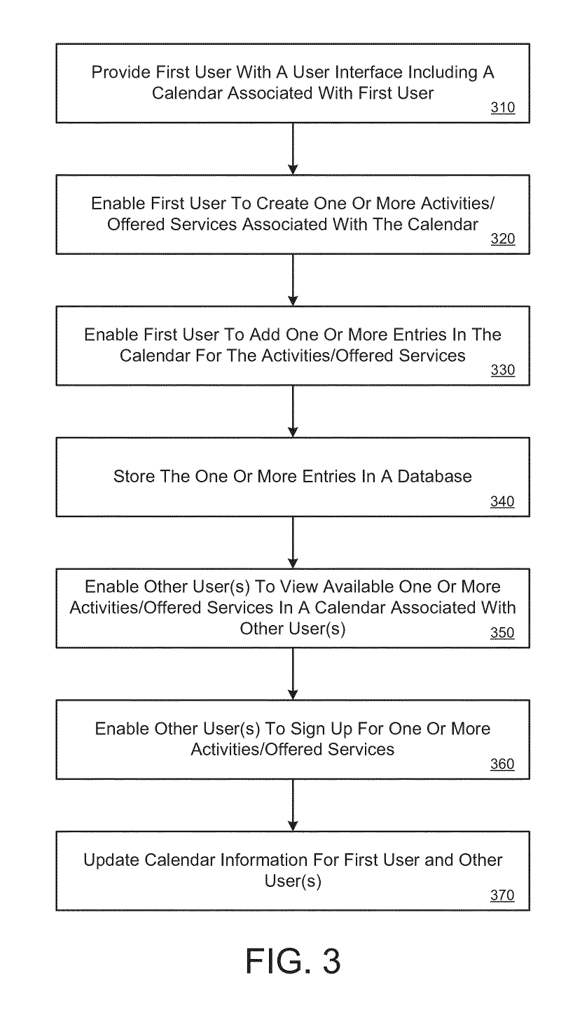

FIG. 3 illustrates another example method for providing calendar services to a user, in another embodiment. A method such as described by an embodiment of FIG. 3 can be implemented using, for example, components described with an embodiment of FIG. 1. Accordingly, references made to elements of FIG. 3 are for purposes of illustrating a suitable element or component for performing a step or sub-step being described.

The calendar system, such as system 100 of FIG. 1, can provide a graphical user interface to a first user (310). The graphical user interface can include a calendar of the first user and other associated information pertaining to the calendar and/or the first user. The first user is enabled to interact with the graphical user interface to create one or more activities or services that the first user wants to offer to other users of the calendar system (320). In one example, the graphical user interface can have a designated section in which activities can be created and/or modified by the first user. For example, the calendar user interface can include an activities section in which the first user can create new activities and view/edit/delete activities that the first user has previously created.

When the first user wants to offer an activity (e.g., a massage) to other users, the first user can select the activity from the activities section and drag the selected activity to a particular time frame or duration on the first user's calendar (330). The first user's calendar is dynamically updated with an entry of the activity at a time slot in which the first user dragged and dropped. The first user can select and drag the activity to the other time slots in the first user's calendar as many times as desired, in order to cause more entries for the activity to be provided at various time slots.

The calendar system stores the one or more entries for the activity in the calendar database (340). For example, the calendar update 130 can update the first user's calendar in the calendar database 150 to include entries added by the first user. Other users that follow the first user can view the offered activity/service on their respective calendars (350) and can sign up for one or more of the offered activities/services (360). In response to a user signing up for the activity, the calendar system adds an entry for the signed up activity in the respective calendar of the signed up user, and modifies information for the signed up activity in the calendar of the first user (370).

User Interface Examples

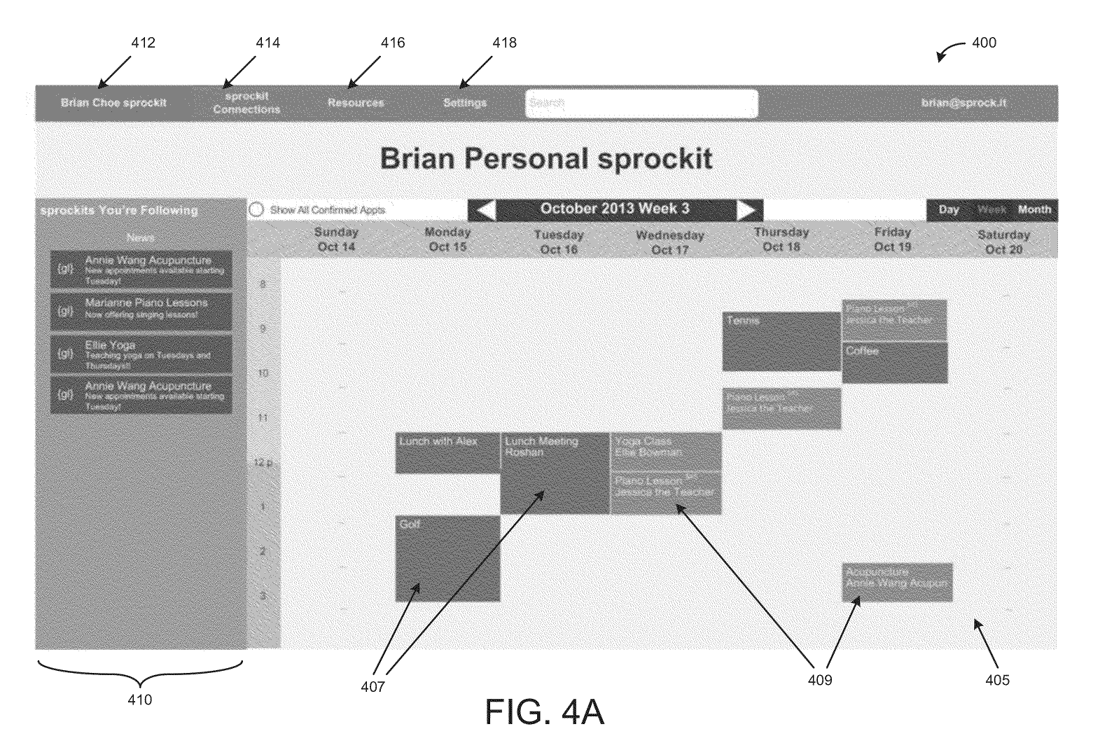

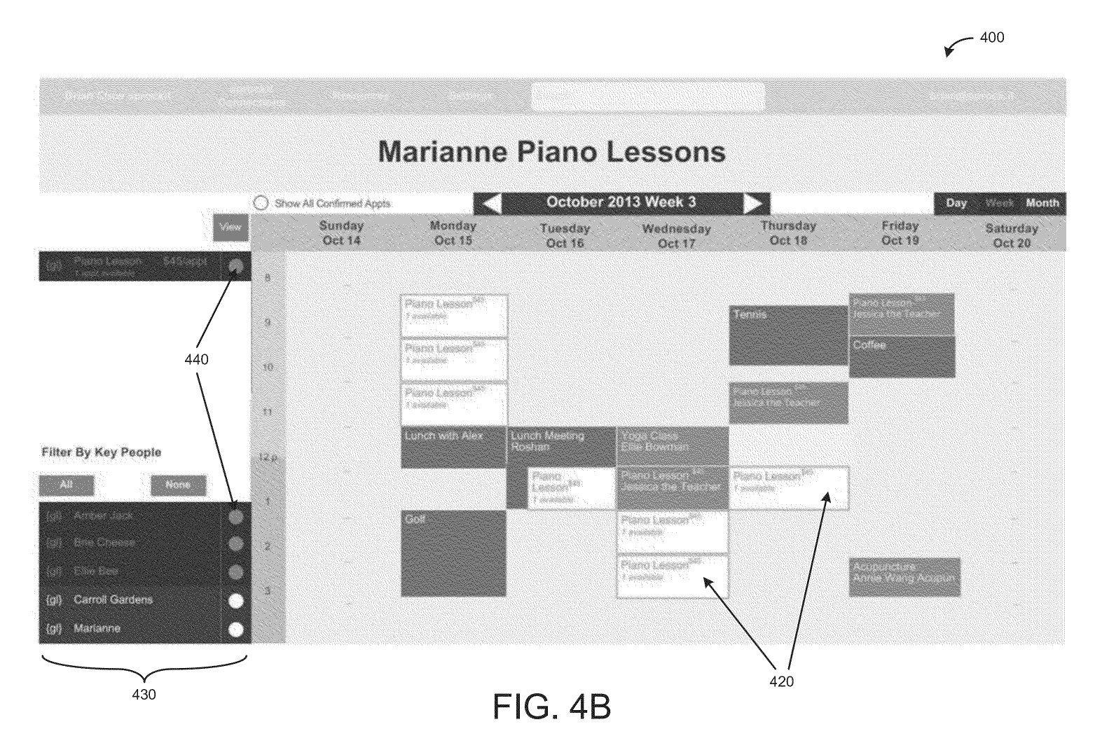

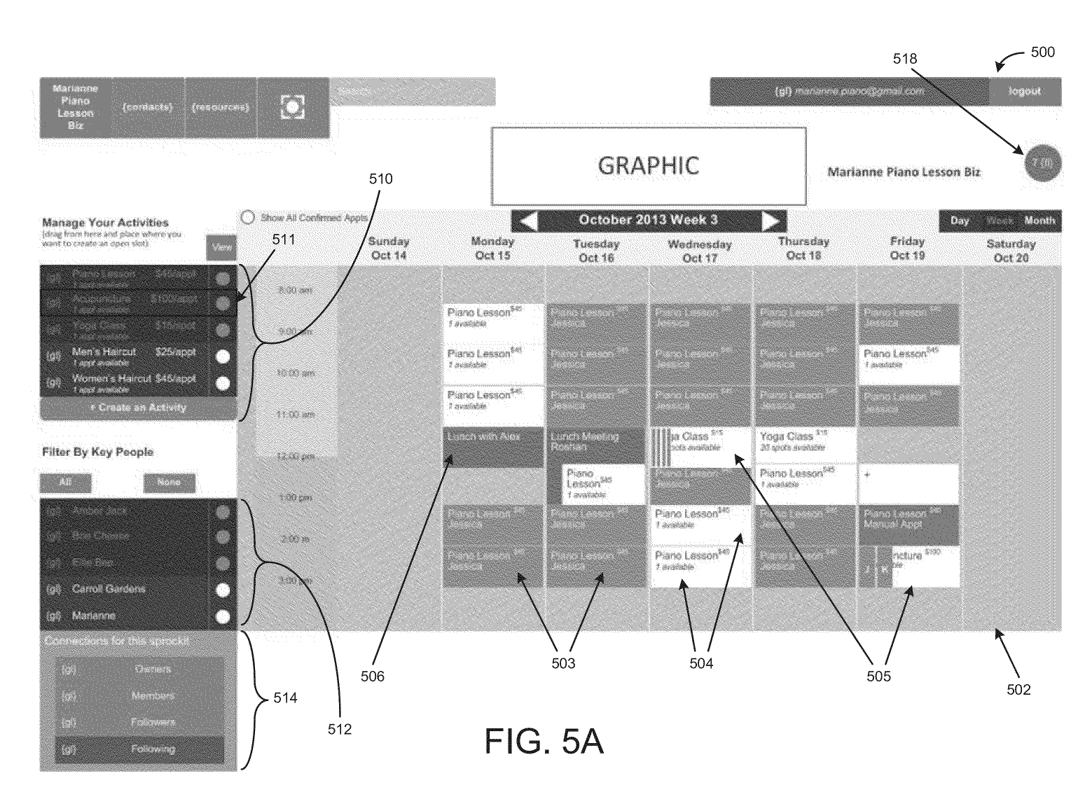

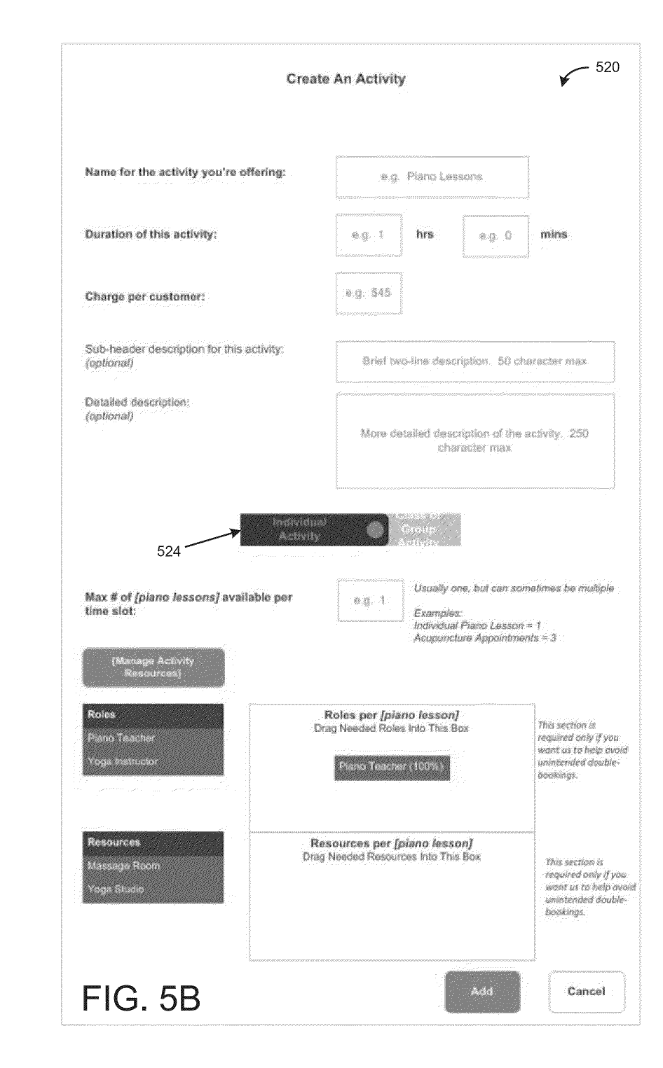

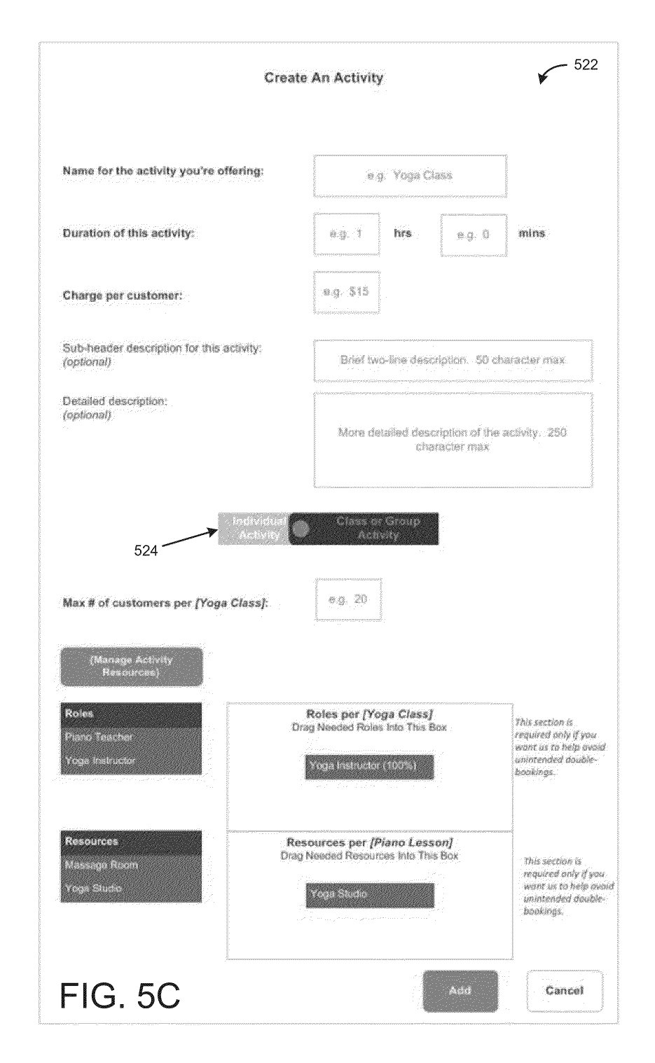

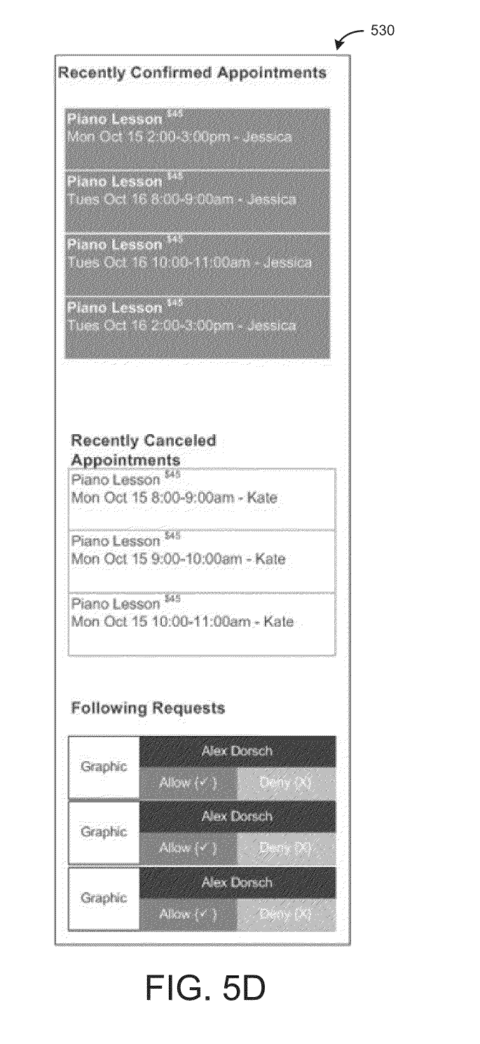

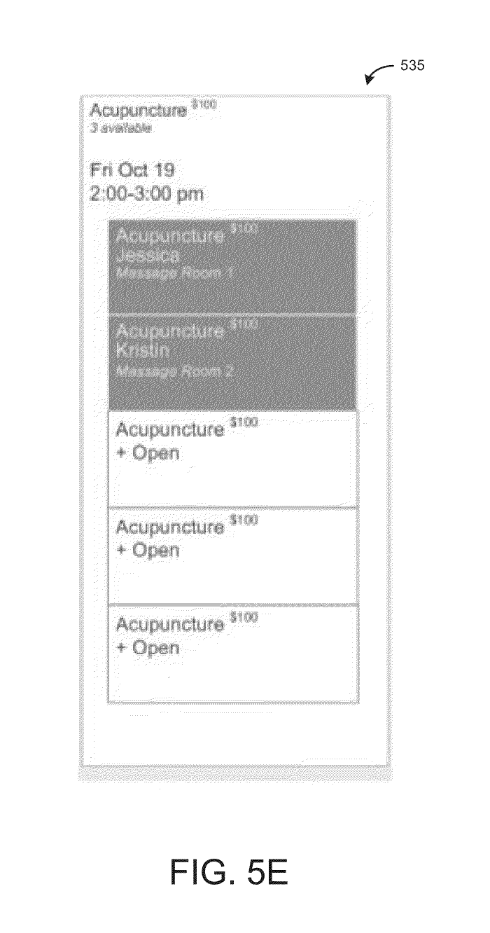

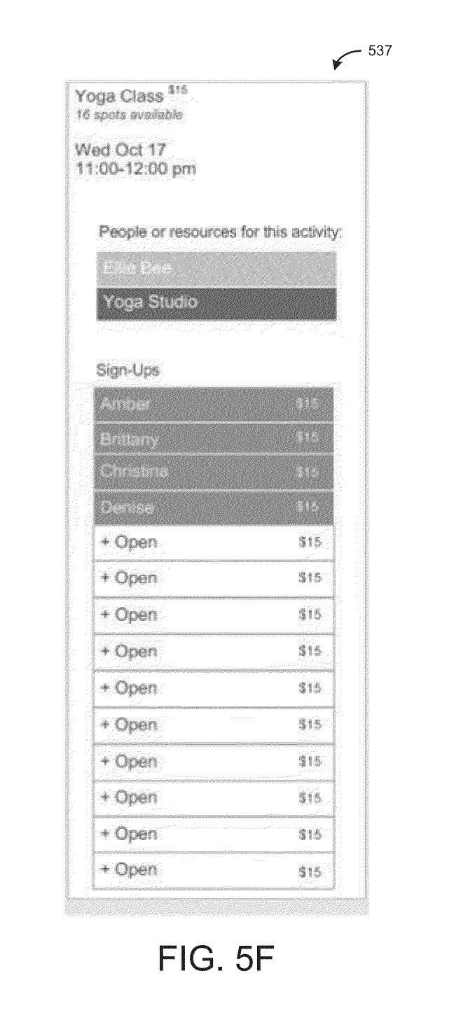

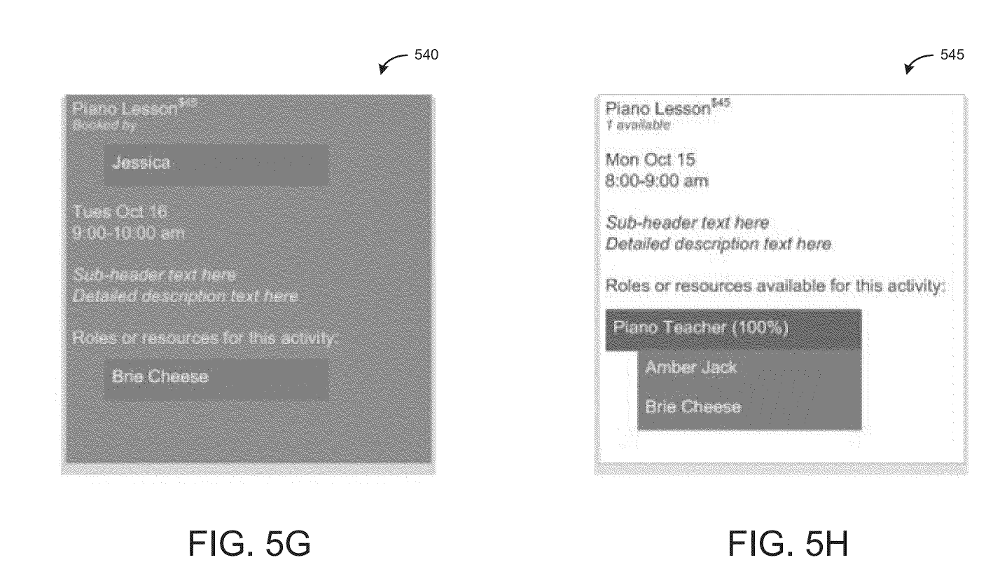

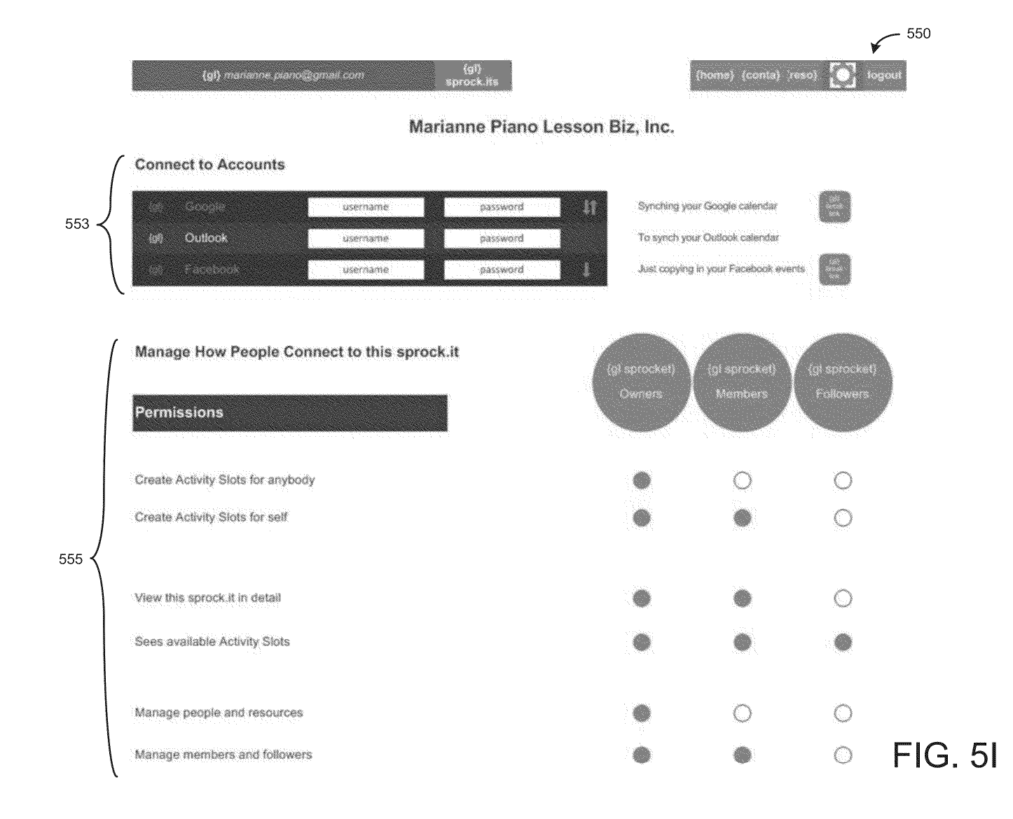

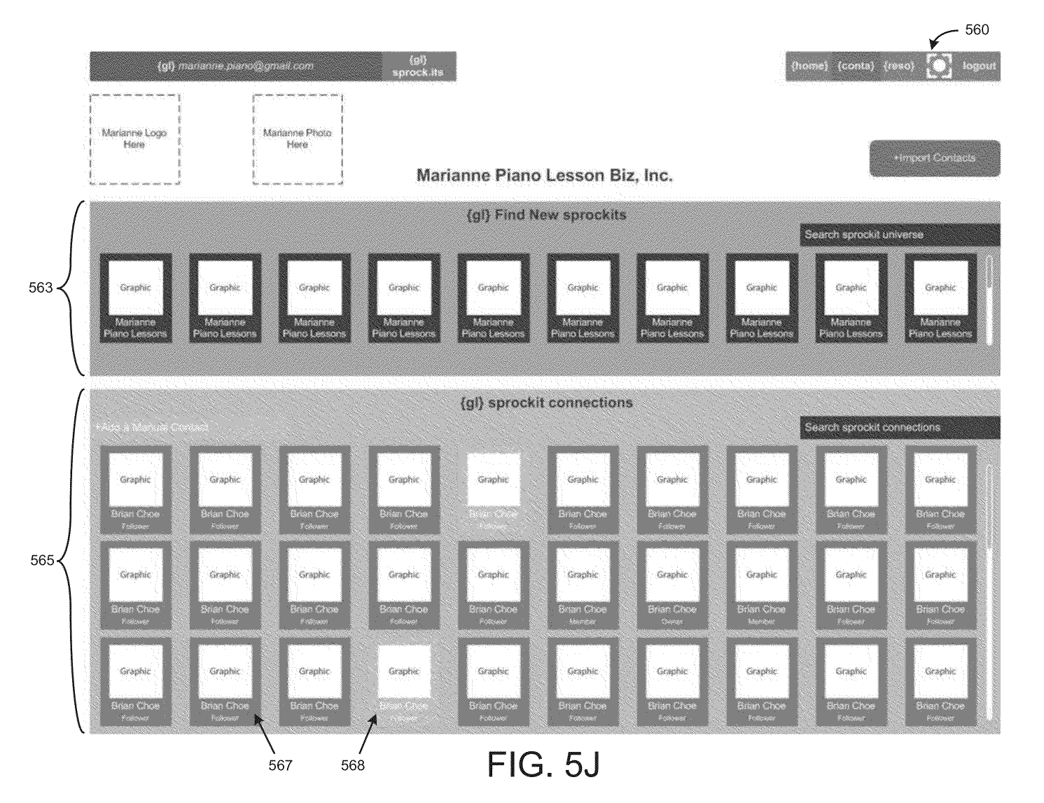

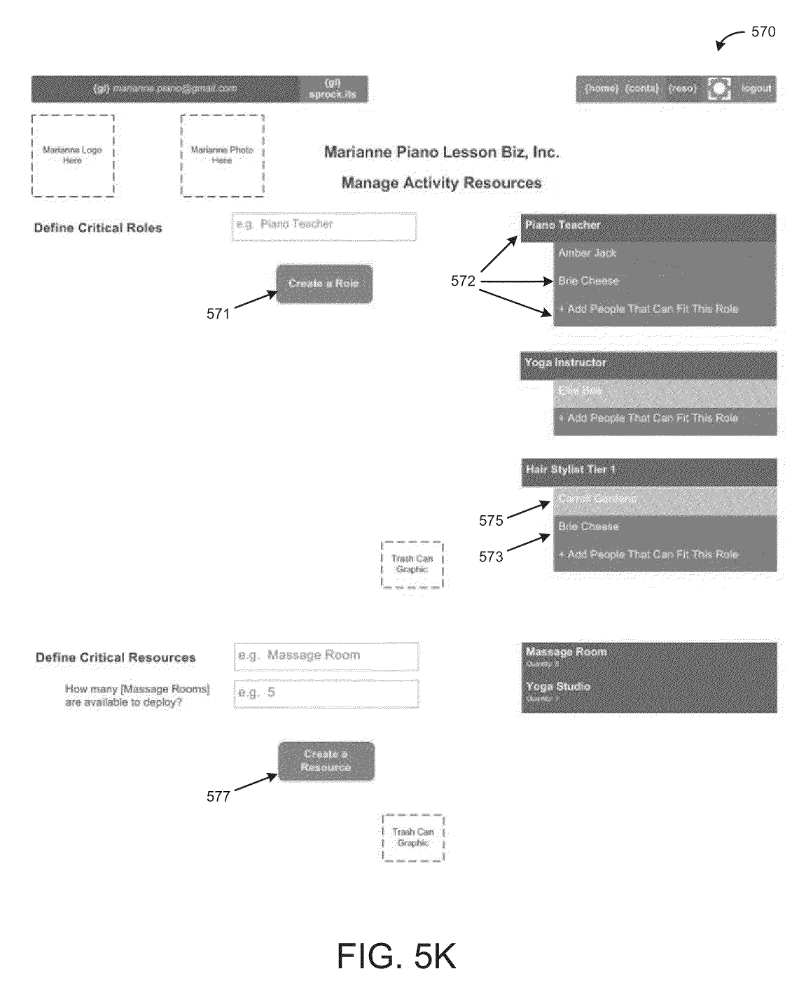

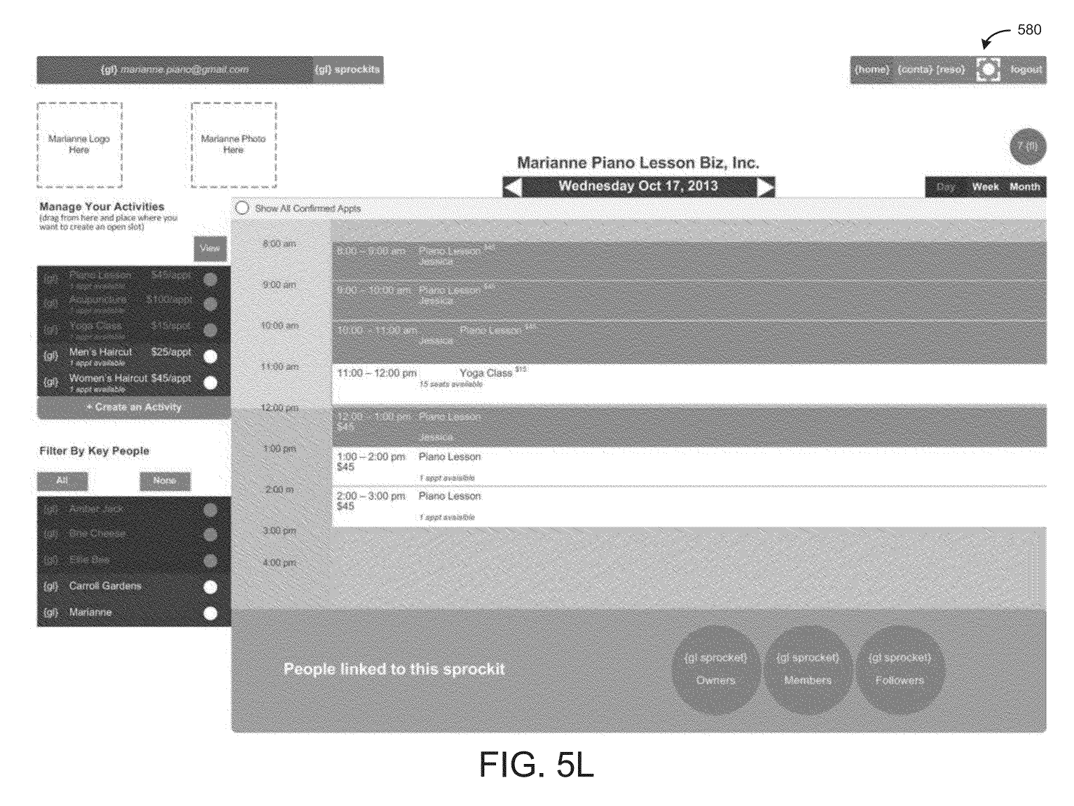

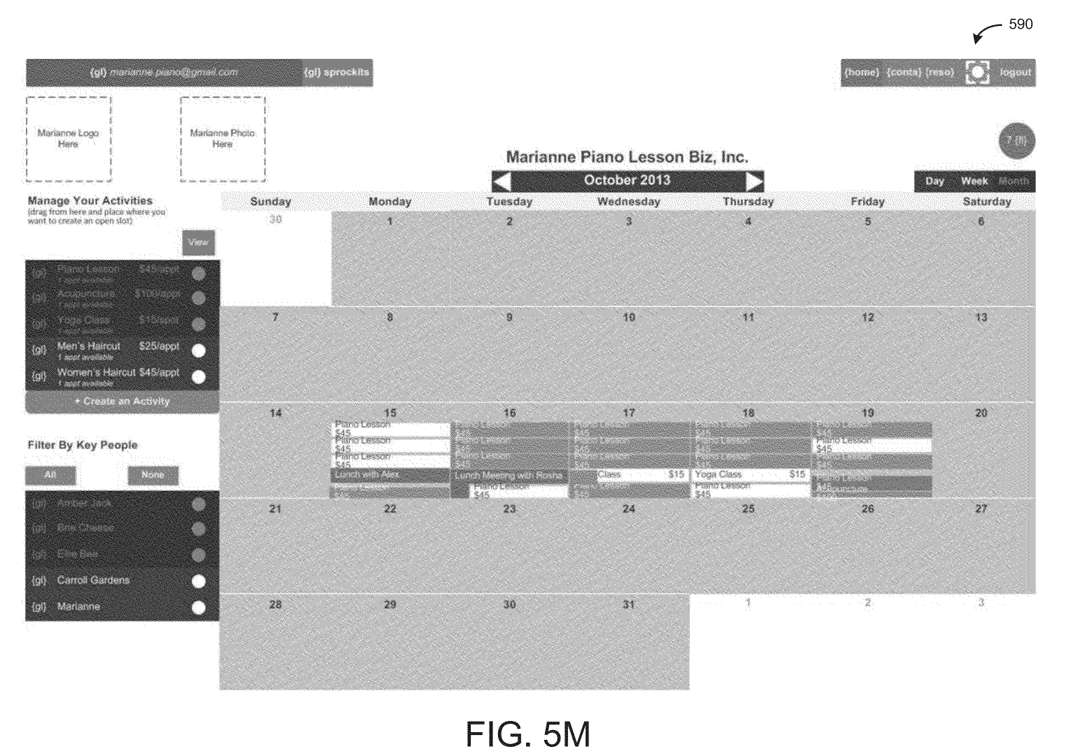

FIGS. 4A and 4B and FIGS. 5A through 5M illustrate example user interfaces that are displayed on a user's computing device, in various embodiments. The user interfaces illustrate various user interfaces and pop-up features/windows that can be displayed on a user's computing device (e.g., laptop computer, smart phone, tablet device, etc.). For example, a user can interact with a web browser application/program running on his or her computing device and visit and view a webpage that provides the user interfaces. In another example, the user can operate a calendar application on the user's computing device to view the user interfaces. Such a calendar application can be offered by an entity that provides the calendar system (as described with FIG. 1). For example, the user can download and install the calendar application on his or her computing device and register with the calendar system.

FIG. 4A illustrates a calendar graphic user interface 400 that is displayed on a user's computing device. In one example, the calendar graphic user interface 400 can be displayed to the user (e.g., Brian) once the user has properly logged into his account. The calendar graphic user interface 400 illustrates a week view (e.g., week three of October 2013), but can be toggled by the user (e.g., via selectable features “Day,” “Week,” or “Month”) to change view modes into a day view or month view.

According to examples, the calendar graphic user interface 400 includes a calendar 405 for the user, which includes tiles or blocks of calendar entries that have been added by the user or added automatically in response to the user joining or signing up with an activity offered by another user. For example, the calendar 405 can include personal entries 407 (e.g., “Golf” or “Lunch with Alex”), work entries (not shown in FIG. 4A) (e.g., “Work meeting” or “Project due date”), activity entries 409 that have been joined or signed up by the user (e.g., “Piano Lesson” by Jessica or “Acupuncture” by Annie Wang), or other types of entries (e.g., entries for different organizations the user is a part of, family-related entries). Depending on implementation, the different types or categories of entries can be distinguishable between each other using colors, graphics, patterns, etc., in the displayed tiles of the calendar 405.

In some examples, the events that have been manually added by the user can be modified or deleted by the user by selecting on the tile. When the user selects the tile, a pop-up window appears adjacent to or near the selected tile to show additional details about the entry as well as to enable the user to make modifications to the entry (e.g., change the duration or start time/date of the entry, change the description or title, change the location, specify options for repeatability, delete the entry, etc.). On the other hand, in some embodiments, activity entries 409 that have been joined or signed up by the user (but is offered by another user) cannot be modified by the user (e.g., except to disjoin or leave the class/service), unless permission is granted by the offering user. In some examples, the user can propose a change or modification to an activity entry (e.g., change the price for the service or change the start time/date), and the calendar system can notify the offering user of the proposed modification by the user and provide the offering user with a chance to accept or decline the modification.

The calendar graphic user interface 400 can also include an association (or following) section 410, which provides information about other users and/or calendars of other users the user, Brian, is following. In the example provided, Brian is following a calendar (e.g., a sprockit or sprock.it) belonging to (i) Annie Wang, who offers acupuncture services, (ii) Marianne, who offers piano lessons, and (iii) Ellie, who offers yoga classes. Depending on variation, the association section 410 can provide selectable features for each of the users or calendars that the user follows, and/or selectable features for updated news or notifications pertaining to the users or calendars that the user follows (e.g., a new activity has been offered by an offering user).

The calendar graphic user interface 400 can also include additional selectable features, such as feature 412, that, when selected by the user, provides the user with a pop-up window showing the user's other calendars (if any) (e.g., the user has a personal calendar and a professional/business calendar). Feature 414, when selected, provides a detailed view (as a new webpage or as a pop-up window) of other users that the user, Brian, is following, as well as a detailed view of users that are following Brian's calendar or sprockit. In addition, when feature 414 is selected by the user, the user has an option to search for and find other users to follow. Feature 416, when selected, provides a detailed view of resources that the user interacts with or needs when creating new activities (discussed in more detail below). Feature 418, when selected, provides a detailed view of configurable settings for the user and the user's calendar.

FIG. 4B illustrates the calendar graphic user interface 400 for the user, Brian, with a calendar overlay corresponding to a user, Marianne, that Brian follows. The calendar overlay can be provided to lay over the user, Brian's, calendar and shows the name of the user that Brian follows (Marianne) instead of Brian's name (such as seen in FIG. 4A). In this manner, the user can be sure that he is viewing the calendar overlay instead of his own calendar. In addition, in some examples, when the calendar overlay for another user/business owner is provided on the calendar graphic user interface 400 for the user, portions of the calendar graphic user interface 400 can be dimmed, blurred, lightened in color, etc., to identify to the user, Brian, that he is viewing calendar content from another user, Marianne, in addition to his own calendar entries. For example, in FIG. 4B, the portion of the interface where the selectable features 412, 414, 416, 418 are provided are lightened in color.

The calendar overlay can include entries 420, shown in white in FIG. 4B, that (i) correspond to a calendar of an offering user that Brian follows (e.g., Marianne), and (ii) are available for the user to sign up or join. Marianne may offer more than 7 one-hour long piano lessons for $45 each, but on Brian's calendar graphic user interface 400, entries for only available activities are shown (e.g., Marianne may have 8 more one-hour long piano lessons that have already been booked by other users). According to examples, entries that are associated with Brian's calendar are visually distinguishable from entries 420 of the calendar overlay using different colors, graphics, patterns, etc. In addition, depending on implementation, available entries 420 that conflict with entries in the user's, Brian's, calendar, can be filtered out (e.g., not displayed on the calendar graphic user interface 400) or can be shown as a smaller tile, such as illustrated in FIG. 4B, to indicate to the user that there is a conflict in time.

Still further, in another example, when the user, Brian, is viewing calendar content associated with another user (e.g., Marianne), the calendar graphic user interface 400 can also display an toggle section 430. The toggle section 430 can display a sub-section showing the different activities provided by the offering user (e.g., piano lesson for one hour for $45, or a piano lesson for two hours for $85, etc.), and in some instances, a sub-section showing individuals or members associated with the offering user (e.g., other piano teachers that work with or work for Marianne that will provide the actual service that Marianne sets up). The user can toggle on or off tiles of activities provided by the offering user, Marianne, by selecting one or more selectable features 440 for the different activities and/or the different members. For example, in FIG. 4B, the user has toggled on “Piano Lesson” for $45/appt while toggling off “Piano Lesson” for $85/appt, and toggled on three different members that are associated with Marianne (“Amber Jack,” “Brie Cheese,” and “Ellie Bee”) while toggling off two members (“Carroll Gardens” and “Marianne”). In this manner, the user can filter which tiles for activities to view using the toggle section 430 of the calendar overlay.

FIG. 5A illustrates a calendar graphic user interface 500 that is displayed on a user's computing device. The calendar graphic user interface 500 is similar to the calendar graphic user interface 400 of FIG. 4A. For example, like the calendar graphic user interface 400, the calendar graphic user interface 500 can include a main calendar for a user as well as various selectable features, such as a home feature, a contacts/connections feature, a resources feature, and a settings feature.

In the example provided in FIG. 5A, the user, Marianne, can operate a business, such as Marianne Piano Lesson Biz, that provides a variety of different activities to other users of the calendar system 100 (e.g., a piano lessons, acupuncture sessions, yoga classes, haircuts). The user's calendar graphic user interface 500 includes a plurality of tiles of entries that includes entries 503 for activities offered by Marianne Piano Lesson Biz and that have been joined or signed up by other users, entries 504 for activities offered by Marianne Piano Lesson Biz, but that have not yet been joined or signed up by other users, entries 505 for activities offered by Marianne Piano Lesson Biz that have been partially filled up (e.g., an activity in which multiple users can sign up for the activity in the same time slot), and entries 506 that are personal to Marianne.

The entries can provide information to the user, such as whether the service at the time slot is available, who has signed up, the amount for the service, what the service is, etc. When the user selects (or hovers over with a cursor) an entry 503 that has been booked, for example, additional details can be provided in a pop-up window adjacent to or proximate to the selected entry 503. In one example, the pop-up window 540 is illustrated in FIG. 5G, which includes the name of the user who booked the activity, the date and time, and roles or resources needed for the activity, such as the name of a member associated with the user or the user's business that is providing the service and/or a venue or room location where the activity is being provided. In another example, when the user selects (or hovers over with a cursor) an entry 504 that has not yet been booked, a pop-up window 545, such as illustrated in FIG. 5H, can be displayed to the user.

The entries 505 that have been partially booked (e.g., the maximum capacity has not yet been met by users) in the calendar 502 shows a tile with multiple bars (distinguishable by color or pattern from the remaining portions of the tile) indicating to the user that multiple users have signed up, but that the activity is not full to its capacity. When the user selects (or hovers over with a cursor) an entry 505 that has been partially booked, additional details can be provided in a pop-up window adjacent to or proximate to the selected entry 505, such as illustrated in FIGS. 5E and 5F. In one example, the pop-up window 535 in FIG. 5E corresponds to the acupuncture activity in which two users have been booked and three available spaces for users are still remaining, while the pop-up window 537 in FIG. 5F corresponds to the yoga class activity in which four users have been booked or signed up and sixteen available spaces for users are still remaining. The bars can help quickly indicate to the user, Marianne, how many users have signed up for group activities without having to select or view detailed information. Depending on implementation, other graphical indicators may be used instead of bars, such as horizontal lines, hash marks, icons (such as an icon of a person), stars, etc.

The calendar graphic user interface 500 also includes a selectable notification graphic 518 that provides a number (e.g. “7”) of recent notifications that pertain to the user and/or connections to the user. When the user selects (or hovers over with a cursor) the notification graphic 518, a notification pop-up window 530, such as illustrated in FIG. 5D, can be provided on the calendar graphic user interface 500. The notification pop-up window can include a plurality of selectable features that correspond to recently confirmed (or joined) activities or appointments, recently canceled activities or appointments, and/or requests to follow by users. Each of the provided features can be selected (or hovered over with a cursor) by the user to view additional details. In one variation, the notification window can be concurrently displayed next to the calendar 502 and its contents dynamically updated without user selection of the notification graphic 518.

In addition, the calendar graphic user interface 500 can also include an activities section 510, a members section 512, and a connections section 514. In the activities section 510, the user can view, add, and/or edit the activities provided by the user and/or the user's business. The user can also filter which entries for activities to see in the user's calendar 502 by toggling on or off certain activities in the activities section 510. Similarly, the user can filter which entries for activities to see in the user's calendar 502 by toggling on or off certain members that are providing service for the different activities in the members section 512. In the example provided, the user has toggled off “Men's Haircut” and “Women's Haircut” activities and “Carroll Gardens” and “Marianne” members from appearing on the user's calendar 502. The connections section 514 provides selectable features showing “owners,” the users that own or operate the calendar or sprockit for Marianne Piano Lesson Biz, “members,” the users that are associated with the business and provide one or more services on behalf of the business (e.g., as an employee), “followers,” the users that are following this calendar 502, and “following,” the users or users' calendars that this user or business is following. Selecting the individual features can provide additional details about the different connections to the user's calendar.

Referring back to the activity section 510, the user can add entries in the calendar 502 by selecting an activity from the activities section 510 and moving it to the calendar 502. For example, when the user selects the feature 511, labeled “Acupuncture,” the user can then drag it over to the calendar 502 and drop it in the desired time slot in the calendar 502 (e.g., using a touch gesture on a touch-sensitive display or using a mouse or trackball). According to embodiments, when the user begins to drag the selected feature 511, a phantom (or similarly shaped graphic) of the feature 511 moves in motion from the original position of the feature 511 in accordance with the drag motion. Once a portion of the phantom of the feature 511 (e.g., half of the phantom or a majority of the phantom) crosses the boundary between the activity section 510 and the calendar 502, the phantom of the feature 511 dynamically changes shape and size to be reflective of the duration of the selected activity with respect to time scale the calendar. For example, if an activity had a duration of four hours, once the user dragged the activity feature from the activity section 510 to the calendar 502, a tile would be shown in place of the phantom having a size that is four times the size of a displayed “Piano Lesson” tile in the calendar 502.

Still further, when the user wants to add an activity to the activities section 510, the user can select a feature, such as the “Create an Activity” feature to create a new activity. In one example, when the user provides input to create a new activity, an interface 520 illustrated in FIG. 5B can be displayed. The interface 520 is similar to the interface 522 of FIG. 5C, except that the user has toggled a switch 524 indicating that the new activity will be an “individual activity” as opposed to a “class or group activity.” The interface 520 of FIG. 5B includes fields that can be filled out by the user, such as the name of the activity, the duration, the charge per customer, sub-header description, detailed description, the max number of activity sessions available per time slot (e.g., for one-on-one piano lessons, usually one session is available per hour, whereas for acupuncture services, an acupuncturist can work on two or three people in a time slot). The user can also identify roles and resources, if necessary, such as an individual or member that can provide the service, or rooms (e.g., acupuncture rooms), equipment (e.g., massage table), etc. needed to provide the service, respectively. As discussed, the interface 522 of FIG. 5C is similar to the interface 520 of FIG. 5B except the user has selected the switch 524 indicating that the new activity will be a “class or group activity.” In such case, the user can specify the maximum number of people that can participate in the group class or activity (e.g., twenty people for a yoga class). Once the user has provided the information, the user can add the activity to the activity list by selecting the “Add” feature or cancel creating the new activity by selecting the “Cancel” feature. After the user creates a new activity, the newly created activity will be added as a selectable feature to the list of activities in the activities section 510.

Depending on implementation, the interfaces 520, 522 can also include additional features (not shown in FIGS. 5B and 5C). For example, the user can create a new activity that is conditional on one or more other factors. The user can, for example offer a yoga class session on Saturday morning at 10 am, contingent on a sufficient (threshold) number of people that sign up for the activity by a certain deadline (e.g., 9 pm the night before on Friday). If enough people, such as 10 users, joins or signs up for the activity by the deadline, the activity will be offered and remain active on the user's calendar (as well as the calendars of the individuals that signed up for the activity). If not, the activity is removed from the calendars of the affected users. According to some examples, the calendar system can also provide confirmation emails or notification messages to the affected users indicating that the sufficient threshold has been met or not met.

In another example, the user can create an activity for a group of users and select a feature to enable the users to communicate with each other. For example, a group of users that are in a club or association (or training for a triathlon together) can follow or be associated with each other using their respective calendars. A scheduled activity for the group can include a two-hour individual training session. A user can individually check-off, mark, or toggle a box or input field showing other users of that group and that are joined in the activity that he or she has completed the required training exercise.

FIG. 5I illustrates a settings (or menu) graphic user interface 550 that is displayed on a user's computing device. According to an embodiment, the settings graphic user interface 550 can be displayed in response to a user selecting the settings feature from the calendar graphic user interface 500 of FIG. 5A. The settings graphic user interface 550 includes a plurality of selectable options that enable the user to personalize or configure his or her calendar. In the example provided, the user's calendar corresponds to the user's business, Marianne Piano Lesson Biz, as shown at the top or upper region of the settings graphic user interface 550.

In some examples, the settings graphic user interface 550 can include an accounts section 553 in which the user can select which third party services to synchronize the user's calendar with. The user/owner of the business can input his or her username and password for the other third party services to enable the calendar system to synchronize the user's calendar with one or more other third party services. In one implementation, the calendar system can synchronize the user's calendar with the third party services by retrieving calendar entries or appointments from the other third party services and include them as entries in the user's calendar.

The settings graphic user interface 550 also includes a permissions section 555 in which the user can configure privacy settings and administrative/management settings for the calendar. Depending on implementation, the permissions section 555 can include, for each of users/business owners, members of the user or business, and followers of the user or business, a plurality of options with selectable on/off icons (or check boxes or switches, etc.) that can be toggled by the user/business owner. The options can specify what authorization or permission certain individuals (e.g., users/owners, members, followers) have when interacting with the user's calendar. For example, in the example provided in FIG. 5I, the user has only allowed followers to view available activity entries or slots, whereas members of the user or user's business can be permitted to perform more actions (e.g., view, create, and/or edit other activities or manage other members and followers, etc.). In this manner, a user of the calendar system can have the freedom to manage what kind of information and who can view/edit the information from the user's calendar.

FIG. 5J illustrates a contacts graphic user interface 560 that is displayed on a user's computing device. According to an embodiment, the contacts graphic user interface 560 can be displayed in response to a user selecting the contacts/connections feature from the calendar graphic user interface 500 of FIG. 5A. The contacts graphic user interface 560 can provide information about other users/businesses that the user can follow and/or information about other users/businesses that follow the user or the user's calendar.

In one embodiment, the contacts graphic user interface 560 can include a following section 563 and a followers section 565. The following section 563 can provide a plurality of icons corresponding to other users/businesses that the user is currently following and/or has requested to follow (but has not yet received permission to follow). Each of the icons can be selectable so that, when selected by the user (or when the user hovers over the icon with a cursor), detailed information about the corresponding user/business can be displayed to the user (e.g., via a pop-up window).

The following section 563 also includes a search feature, in which the user can search for other users/businesses to follow. When a search query (e.g., a username or email address or a business category) is inputted, the calendar system can perform a search of users of the calendar system and provide, to the user, results that satisfy the query. When the user submits a request to follow another user, the calendar system can notify the other user, and once the other user permits the user to follow him, the calendar system can associate the user with the other user and/or calendar of the other user. An icon corresponding to the newly associated user can be provided in the following section 563.

The follower section 565 provides a plurality of icons corresponding to other users/businesses that may be currently following the user and/or has requested to follow the user (but the user has not yet granted permission), or users related to the calendar with special permissions, such as owners or members. Again, each of the icons can be selectable so that, when selected by the user (or when the user hovers over the icon with a cursor), detailed information about the corresponding user/business can be displayed to the user (e.g., via a pop-up window). In one example, in the follower section 565, an icon corresponding to another user/business that is currently following the user (icon 567) can be distinguishable from (i) an icon corresponding to another user/business that has requested to follow the user, but has not yet been granted permission, and/or (ii) an icon corresponding to another user/business/contact that has been manually added by the user, but does not have an account with the system (icon 568). Again, the user can select (or hover over with a cursor) the icon 568 to view a pop-up window that shows information about the corresponding user.

FIG. 5K illustrates a resources graphic user interface 570 that is displayed on a user's computing device. According to an embodiment, the resources graphic user interface 570 can be displayed in response to a user selecting the resources feature from the calendar graphic user interface 500 of FIG. 5A. The resources graphic user interface 570 provides the user with options to manage the resources that the user or user's business needs with respect to the activities or services the user offers. As discussed, resources can include roles, such as an individual or member that can provide the service, or resources, such as rooms (e.g., yoga studio, acupuncture rooms) or equipment (e.g., massage table) needed to provide the service. By interacting with the resources graphic user interface 570, a user can create a role and/or a resource for a particular activity.

For example, the user or user's business, Marianne Piano Lesson Biz, offers piano lessons, yoga classes, and hair services. The user can create roles (e.g., by entering a name for the role in the text field and selecting the feature 571) and for individual roles, the user can add members (e.g., users that are a part of the business or employees) to certain roles. In the example described in FIG. 5K, the user has added two people, Amber Jack and Brie Cheese, as members who can perform the role of a piano teacher. For hair services, the user has added two people, Carroll Gardens and Brie Cheese, as members who can perform the role of a hair stylist. The user can also add/edit the member for the roles or edit the roles by selecting and interacting with each of the features 572. In one example, the user can remove a member from a role or delete a role by selecting and dragging a corresponding feature 572 to an icon or graphic of a trash can. Similarly, the user can create a resource that is necessary for providing an activity (e.g., by entering a name for the resource and a number of resources available in the text fields, and selecting the feature 577). The user can view/edit the resource or delete the resource by selecting the corresponding feature or by selecting and dragging the corresponding feature to the graphic of a trash can.

According to embodiments, a selectable feature of a member that has an account with the calendar system (e.g., the member has her own calendar with the calendar system) (feature 573) can be distinguishable from a selectable feature of a member that does not have that does not have an account with the calendar system (feature 575). When the user creates an entry for an activity on the user's calendar (such as described in FIG. 5A), in which a member (e.g., “Brie Cheese”) is designated as being able to perform the role for that activity, and the member has her own account with the calendar system, the calendar system can also create an entry for that activity on the member's calendar (e.g., on Brie Cheese's calendar). On the other hand, when the member does not have her own account, the calendar system cannot create the entry for that member. By differentiating between members that have an account versus members who do not have an account using distinguishable features (e.g., colors or patterns, etc.), the user can determine whether he or she needs to further communicate with the members.

FIG. 5L illustrates a calendar graphic user interface 580 that is similar to the calendar graphic user interface 500 of FIG. 5A, but corresponds to a day view instead of a week view. The calendar graphic user interface 580 has similar features and functionality such as described with respect to the calendar graphic user interface 500. FIG. 5M illustrates a calendar graphic user interface 590 that is similar to the calendar graphic user interface 500 of FIG. 5A, but corresponds to a month view instead of a week view. Similarly, the calendar graphic user interface 590 has similar features and functionality such as described with respect to the calendar graphic user interface 500.

Hardware Diagram

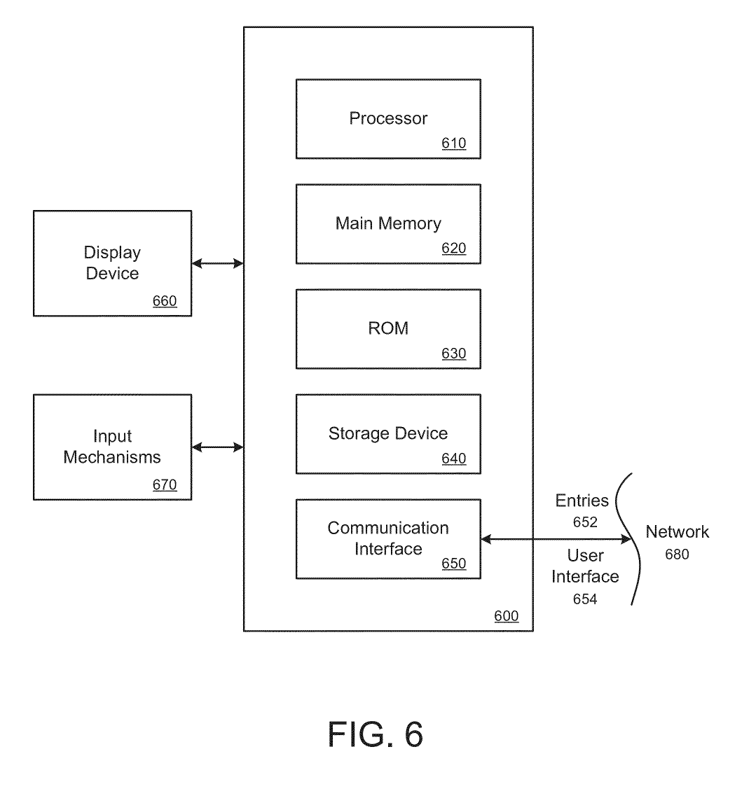

FIG. 6 is a block diagram that illustrates a computer system upon which examples described herein may be implemented. For example, in the context of FIG. 1, system 100 may be implemented using a computer system such as described by FIG. 6. System 100 may also be implemented using a combination of multiple computer systems as described by FIG. 6.

In one implementation, computer system 600 includes processing resources 610, main memory 620, read only memory (ROM) 630, storage device 640, and communication interface 650. Computer system 600 includes at least one processor 610 for processing information. Computer system 600 also includes a main memory 620, such as a random access memory (RAM) or other dynamic storage device, for storing information and instructions to be executed by the processor 610. Main memory 620 also may be used for storing temporary variables or other intermediate information during execution of instructions to be executed by processor 610. Computer system 600 may also include ROM 630 or other static storage device for storing static information and instructions for processor 610. A storage device 640, such as a magnetic disk or optical disk, is provided for storing information and instructions, such as instructions for providing features and steps described with respect to FIGS. 1 through 5M.

The communication interface 650 can enable the computer system 600 to communicate with one or more networks 680 (e.g., cellular network) through use of the network link (wireless or wireline). Using the network link, the computer system 600 can communicate with one or more computing devices and one or more servers. In some variations, the computer system 600 can be configured to receive information associated with calendar entries 652 provided from one or more computing devices (e.g., belonging to users) via the network link. The information associated with calendar entries 652 can be processed by the processor 610 and can be stored in, for example, the storage device 640 or other storage devices communicatively coupled to the computer system 600. The processor 610 can also provide user interface features 654 to the users' computing devices over the network 680.

Computer system 600 can also include a display device 660, such as a cathode ray tube (CRT), an LCD monitor, or a television set, for example, for displaying graphics and information to a user. An input mechanism 670, such as a keyboard that includes alphanumeric keys and other keys, can be coupled to computer system 600 for communicating information and command selections to processor 610. Other non-limiting, illustrative examples of input mechanisms 670 include a mouse, a trackball, touch-sensitive screen, voice-recognition, or cursor direction keys for communicating direction information and command selections to processor 610 and for controlling cursor movement on display 660.

Examples described herein are related to the use of computer system 600 for implementing the techniques described herein. According to one embodiment, those techniques are performed by computer system 600 in response to processor 610 executing one or more sequences of one or more instructions contained in main memory 620. Such instructions may be read into main memory 620 from another machine-readable medium, such as storage device 640. Execution of the sequences of instructions contained in main memory 620 causes processor 610 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A method for providing a calendar service to a first user, the method being performed by one or more processors and comprising:
providing, to a computing device of the first user, a user interface that includes a calendar of the first user;
associating the first user with a calendar of a second user;
enabling the first user to view, on the calendar associated with the first user in the user interface, one or more activities offered by the second user, the one or more activities capable of being individually joined by the first user;
receiving a user input to join an activity offered by the second user; and
in response to receiving the user input, (i) adding an entry for the joined activity in the calendar of the first user, and (ii) modifying information for the joined activity in the calendar of the second user.

2. The method of claim 1, wherein enabling the first user to view the one or more activities offered by the second user includes providing the one or more activities offered by the second user as an overlay to one or more calendar entries of the calendar of the first user.

3. The method of claim 2, wherein enabling the first user to view the one or more activities offered by the second user includes providing only activities offered by the second user that are available for the first user to join.
